(19) United States
(12) Patent Application Publication
(10) Pub. No.: US 2019/0086883 A1
(43) Pub. Date: Mar. 21, 2019

(54) CONTROL APPARATUS, CONTROL METHOD, AND NON-TRANSITORY STORAGE MEDIUM

(71) Applicant: NEC Corporation, Tokyo (JP)

(72) Inventors: Hidekazu KIMURA, Tokyo (JP); Hideki TANABE, Tokyo (JP)

(21) Appl. No.: 16/085,443

(22) PCT Filed: Feb. 10, 2017
(86) PCT No.: PCT/JP2017/004872

§ 371 Date: Sep. 14, 2018

(30) Foreign Application Priority Data
Mar. 17, 2016 (JP) 2016-053506

(51) Int. Cl. G05B 15/02; H02J 3/28; G06F 17/11

(52) U.S. Cl. CPC G05B 15/02; G06Q 50/06; G06F 17/11; H02J 3/28

(57) ABSTRACT

A control apparatus (10) including an information acquisition unit (11) that acquires an electric power generation schedule and a fluctuation amount of an output of each of a plurality of electric power generation apparatuses, a first calculation unit (12) that calculates, on the basis of the electric power generation schedule and the fluctuation amount, an electric power generation schedule of the whole of the plurality of electric power generation apparatuses, and a total fluctuation amount at each timing in the electric power generation schedule of the whole of the plurality of electric power generation apparatuses, and a second calculation unit (13) that determines a control schedule of an energy accumulation apparatus on the basis of the electric power generation schedule and the total fluctuation amount of the whole of the plurality of electric power generation apparatuses is provided.

### TECHNICAL FIELD

The present invention relates to a control apparatus, a control method, and a program.

### BACKGROUND ART

An electric power generation apparatus on a consumer side is connected to an electric power distribution network through a device such as a Home Energy Management System (HEMS) or a distribution board. An electric power company receives information on a manufacturer name, a model name, a rated output, and the like of each apparatus from a manufacturer of various electric power generation apparatuses, and performs an examination by a power-system interconnection deliberation with respect to each apparatus. By permitting only apparatuses having a certain level of electric power quality to connect to the electric power distribution network, fluctuation of electric power quality (fluctuation of electric power value, a voltage value, and values of a frequency and the like) of the electric power distribution network caused by the electric power generation apparatus is suppressed within a predetermined range.

Related techniques are disclosed in Patent Documents 1 and 2.

Patent Document 1 discloses a system control system that determines a control target value by a moving average of a voltage value of an interconnection point of an electric power system, and determines a charge and discharge instruction to an electric power storage apparatus that performs a charge and a discharge of electric power on the electric power system through the above-described interconnection point, on the basis of a deviation between the determined control target value and a current voltage value.

Patent Document 2 discloses electric power supply system including a prediction unit that predicts an electric power consumption amount and a generation electric power amount at an electric power consumption point on the basis of weather information at the electric power consumption point at a predetermined future time, a voltage distribution estimation unit that estimates a voltage distribution in an electric power system based on the electric power consumption amount at the electric power consumption point predicted by the prediction unit and a generation electric power amount by a distribution-type electric power generation apparatus, and a supply determination unit that determines whether or not it is possible to normally execute an electric power supply to the electric power consumption point at the predetermined future time on the basis of the voltage distribution.

In the future, in a case where electric power generation apparatuses connected to the electric power distribution network rapidly increase, it is expected that it is physically difficult to perform the described-above examination (power-system interconnection deliberation) on all the electric power generation apparatuses. In a case where connection to the electric power distribution network is allowed without the examination, even an electric power generation apparatus with poor quality can be connected to the electric power distribution network.

In a case where the electric power generation apparatus with poor quality is connected to the electric power distribution network, a new problem that electric power value, a voltage value, and values of a frequency and the like are changed (fluctuated) with time due to especially a performance of a power conditioner occurs, and an accident on a consumer side, a large scale blackout and the like may occur.

### RELATED DOCUMENT

### Patent Document

[Patent Document 1] Japanese Patent Application Publication No. 2015-177624

[Patent Document 2] Japanese Patent Application Publication No. 2010-233352

### SUMMARY OF THE INVENTION

### Technical Problem

In both of the technologies disclosed in Patent Documents 1 and 2, a countermeasure against excessive or insufficient generation electric power with respect to predicted generation electric power of the electric power generation apparatus by providing a supply reserve is described. Here, the supply reserve is an electric power supply unit that maintains a balance of supply and demand in a unit of about a minute to an hour, and there is a problem that it is impossible to reduce the fluctuation caused due to the power conditioner with poor quality.

The present invention provides a unit that solves the above-described problem using adjustment power by a charge and a discharge of an energy accumulation apparatus (which means an electric power supply unit for maintaining electric power quality in a unit of time equal to or less about a minute).

### Solution to Problem

According to the present invention, a control apparatus including an information acquisition unit that acquires an electric power generation schedule and a fluctuation amount of an output of each of a plurality of electric power generation apparatuses, a first calculation unit that calculates, on the basis of the electric power generation schedule and the fluctuation amount, an electric power generation schedule of the whole of the plurality of electric power generation apparatuses, and a total fluctuation amount at each timing in the electric power generation schedule of the whole of the plurality of electric power generation apparatuses, and a second calculation unit that determines a control schedule of an energy accumulation apparatus on the basis of the electric power generation schedule and the total fluctuation amount of the whole of the plurality of electric power generation apparatuses is provided.

In addition, according to the present invention, there is provided a control method executed by a computer, the method including an information acquisition step of acquiring an electric power generation schedule and a fluctuation amount of an output of each of a plurality of electric power generation apparatuses, a first calculation step of calculating, on the basis of the electric power generation schedule and the fluctuation amount, an electric power generation schedule of the whole of the plurality of electric power generation apparatuses, and a total fluctuation amount at each timing in the electric power generation schedule of the whole of the plurality of electric power generation apparatuses, and a second calculation step of determining a control schedule of an energy accumulation apparatus on the basis of the electric power generation schedule and the total fluctuation amount of the whole of the plurality of electric power generation apparatuses is provided.

In addition, according to the present invention, there is provided a program causing a computer to function as an information acquisition unit that acquires an electric power generation schedule and a fluctuation amount of an output of each of a plurality of electric power generation apparatuses, a first calculation unit that calculates, on the basis of the electric power generation schedule and the fluctuation amount, an electric power generation schedule of the whole of the plurality of electric power generation apparatuses, and a total fluctuation amount at each timing in the electric power generation schedule of the whole of the plurality of electric power generation apparatuses, and a second calculation unit that determines a control schedule of an energy accumulation apparatus on the basis of the electric power generation schedule and the total fluctuation amount of the whole of the plurality of electric power generation apparatuses is provided.

### Advantageous Effects of Invention

According to the present invention, it is possible to reduce fluctuation of electric power quality of an electric power distribution network.

### BRIEF DESCRIPTION OF THE DRAWINGS

The above objects, other objects, features, and advantages will be more apparent by the following preferable example embodiment and the accompanying drawings.

FIG. 1 is a diagram conceptually illustrating an example of a hardware configuration of an apparatus of the present example embodiment.

FIG. 2 is a diagram for describing the overall image of a management system of the present example embodiment.

FIG. 3 illustrates an example of a functional block diagram of a control apparatus of the present example embodiment.

FIG. 4 is a diagram schematically illustrating an example of a result calculated by a control apparatus of the present example embodiment.

FIG. 5 is a diagram schematically illustrating an example of a result calculated by the control apparatus of the present example embodiment.

FIG. 6 is a flowchart illustrating an example of a flow of a process of the control apparatus of the present example embodiment.

FIG. 7 is a diagram for describing an operational effect of the control apparatus of the present example embodiment.

### DESCRIPTION OF EMBODIMENTS

First, an example of a hardware configuration of an apparatus (control apparatus) of the present example embodiment will be described. Each unit included in the apparatus of the present example embodiment is realized by any combination of hardware and software centering on a Central Processing Unit (CPU) of any computer, a memory, a program loaded into the memory, a storage unit such as a hard disk that stores the program (capable of storing a program downloaded from a storage medium such as a Compact Disc (CD) or a server or the like on the Internet, besides a stored program from a stage of shipping the apparatus in advance), and an interface for a network connection. In addition, it is understood by those skilled in the art that there are various modifications in realization method and apparatus.

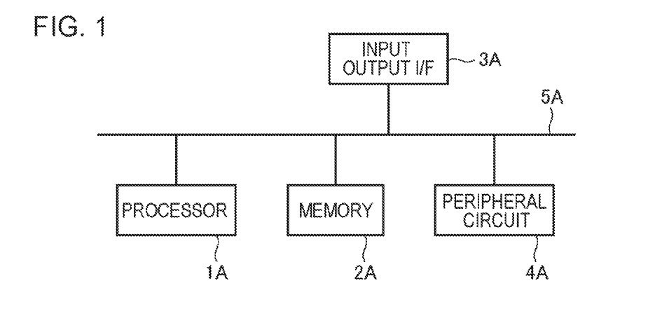

FIG. 1 is a block diagram illustrating the hardware configuration of the apparatus of the present example embodiment. As shown in FIG. 1, the apparatus has a processor 1A, a memory 2A, an input and output interface 3A, a peripheral circuit 4A, and a bus 5A. Various modules are included in the peripheral circuit.

The bus 5A is a data transmission path through which the processor 1A, the memory 2A, the peripheral circuit 4A, and the input and output interface 3A mutually transmit and receive data. For example, the processor 1A is an arithmetic processing unit such as a Central Processing Unit (CPU) or a Graphics Processing Unit (GPU). For example, the memory 2A is a memory such as a Random Access Memory (RAM) or a Read Only Memory (ROM). The input and output interface 3A includes an interface for acquiring information from an external apparatus, an external server, an external sensor, and the like. The processor 1A outputs an instruction to each module and performs an arithmetic operation based on an arithmetic operation result.

Hereinafter, the present example embodiment will be described. Note that a functional block diagram used in the following description of the present example embodiment shows a block of a functional unit not a configuration of a hardware unit. In such figures, it is described that each apparatus is configured with one device, however, its configuration means is not limited thereto. That is, each apparatus may be configured to be physically separated or logically separated. Note that the same reference numerals are given to the same elements, and the description thereof will be suitably omitted.

In the present specification, “acquisition” includes an active acquisition and a passive acquisition. The active acquisition includes an apparatus acquiring data or information stored in another apparatus or a storage medium, for example, the apparatus receiving the data or information by requesting or inquiring to the other apparatus, and reading the data or information by accessing the other apparatus or the storage medium. The passive acquisition includes an apparatus inputting into the apparatus data or information output from another apparatus (passive reception), for example, at least one of receiving distributed (transmitted, push-notified, or the like) data or information, and the like. In addition, the active acquisition includes selecting and acquiring received data or information, and the passive acquisition includes selecting and receiving distributed data or information.

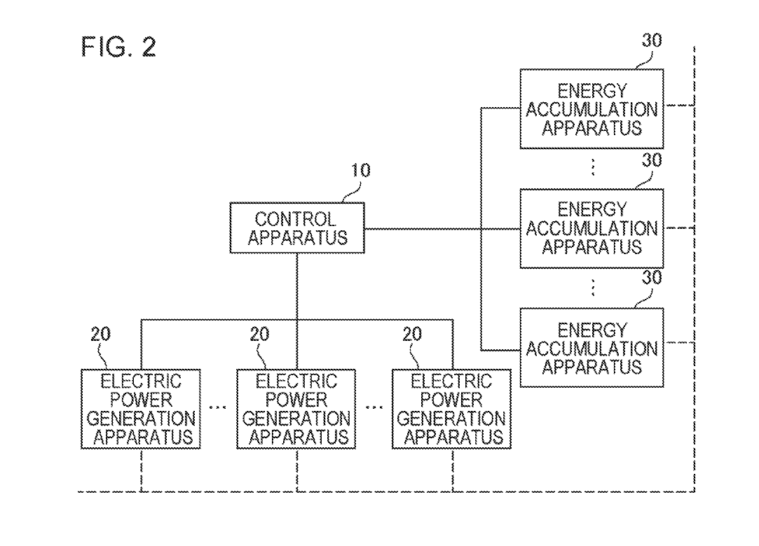

First, the overall image and a problem to be solved of a system of the present example embodiment will be described using FIG. 2. The system of the present example embodiment has a control apparatus 10, an electric power generation apparatus 20, and an energy accumulation apparatus 30. Such apparatuses are connected with each other through a network such as the Internet, and may transmit and receive information.

The electric power generation apparatus 20 has an electric power generation element and a power conditioner. As an example, the electric power generation apparatus 20 is an apparatus that generates electric power using natural energy such as sunlight, wind power, and geothermal power. In this case, the electric power generation element is a solar cell panel or the like, and generates electric power using natural energy. The power conditioner adjusts electric power supplied from the electric power generation element to an electric power distribution network.

The energy accumulation apparatus 30 is an apparatus that accumulates the supplied electric power as predetermined energy. For example, a storage battery that accumulates the supplied electric power as electric power, a heat pump water heater that converts the supplied electric power into thermal energy and accumulates the electric power, and the like are considered, however, the energy accumulation apparatus 30 is not limited thereto.

The control apparatus 10 reduces a fluctuation of electric power quality of the electric power distribution network caused by the electric power generation apparatus 20 by controlling an accumulation of energy to the energy accumulation apparatus 30 and an output of energy from the energy accumulation apparatus 30.

In the present example embodiment, the control apparatus 10 provides adjustment power using the energy accumulation apparatus 30 in a case where a change amount of a total generation electric power [W] with respect to time of a plurality of electric power generation apparatuses 20 is large. The electric power accumulated to or consumed from the energy accumulation apparatus 30 is controlled corresponding to a time change amount of the total generation electric power. Therefore, it is possible to stabilize the electric power [W] supplied from the plurality of electric power generation apparatuses 20 to the electric power distribution network.

However, in the above-described control, the energy accumulation apparatus 30 having an energy input and output amount sufficient to cope with the time change amount of the total generation electric power [W] of the plurality of electric power generation apparatuses 20 is required. In a case where the situation of securing the energy accumulation apparatus 30 is not suitable, a situation in which the time change amount cannot be coped with may occur due to an input and output shortage or the like.

In addition, in a case where the situation of securing the energy accumulation apparatus 30 is not suitable, a situation in which accumulation or output of the energy cannot be executed may occur due to a shortage of an empty capacity [Wh], a shortage of an accumulated energy amount [Wh], or the like.

The problem can be solved, for example, by acquiring an electric power generation schedule of each of the plurality of electric power generation apparatuses 20 in advance, calculating a necessary amount of the energy accumulation apparatus 30 based on the electric power generation schedule, and suitably securing the energy accumulation apparatus 30.

However, in a case where the plurality of electric power generation apparatuses 20 include an electric power generation apparatus 20 with poor quality, the fluctuation of the total generation electric power [W] may occur. In a case where the necessary amount of the energy accumulation apparatus 30 is calculated based on the electric power generation schedule of each of the plurality of electric power generation apparatuses 20 without the consideration of such fluctuation, a shortage of the energy accumulation apparatus 30 may occur. The control apparatus 10 of the present example embodiment includes a unit for solving the problem. Hereinafter, as an example, a control apparatus, a control method, and a program for compensating for electric power quality by output control will be described in detail. Note that it is possible to compensate for the electric power quality using the present invention by the control of a voltage or a frequency as well.

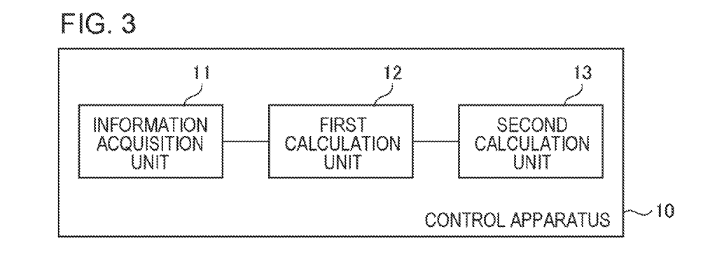

FIG. 3 illustrates an example of a functional block diagram of the control apparatus 10 of the present example embodiment. As shown in the figure, the control apparatus 10 has an information acquisition unit 11, a first calculation unit 12, and a second calculation unit 13.

The information acquisition unit 11 acquires the electric power generation schedule and the fluctuation amount of the output of each of the plurality of electric power generation apparatuses 20.

The electric power generation schedule is a schedule for a predetermined time (for example, one day) and indicates a plan value of the generation electric power [W]. The electric power generation schedule is determined according to the weather of the day, the performance of each electric power generation apparatus 20, or the like. In a method of determining the electric power generation schedule, any technique may be adopted.

The information acquisition unit 11 may acquire the electric power generation schedule of each of the plurality of electric power generation apparatuses 20 from the external apparatus. In addition, the information acquisition unit 11 may hold attribute information such as installation positions and performances of each of the plurality of electric power generation apparatuses 20 in advance, and generate the electric power generation schedule of each of the plurality of electric power generation apparatuses 20 using the information or information (for example, a weather forecast at a predetermined position or the like) acquired on the basis of the information.

The fluctuation amount of the output is a change amount of an actual output value [W] with respect to time. For example, the fluctuation amount is indicated by ±a (a≥0) [W/sec]. Another example of the fluctuation amount includes a frequency component excluding a commercial frequency in a power spectrum (frequency characteristic) of time-varying output, and the like. For example, such a fluctuation amount is considered to be caused by an output performance of the power conditioner.

In a case where the fluctuation amount of each electric power generation apparatus 20 is measured by a manufacturer or the like of the electric power generation apparatus 20 and is published, the fluctuation amount may be used in the present example embodiment.

As another example, the fluctuation amount of each electric power generation apparatus 20 may be measured by causing the electric power generation apparatus 20 to perform a test operation. For example, the electric power generation apparatus 20 may be caused to perform a test operation of outputting a predetermined electric power [W], and an actual output value [W] at that time may be measured for a predetermined time. In addition, the frequency component excluding the commercial frequency in the power spectrum (frequency characteristic) of time-varying output, and the like may be calculated in addition to ±a [W/sec] obtained from the measurement result.

The control apparatus 10 may store the fluctuation amount of each electric power generation apparatus 20 obtained as described above in a storage unit (not shown) in association with each electric power generation apparatus 20 in advance. The storage unit may be included in the control apparatus 10 or may be included in another external apparatus configured to be communicable with the control apparatus 10. In addition, the information acquisition unit 11 may acquire the fluctuation amount of each electric power generation apparatus 20 from the storage unit.

In addition, each electric power generation apparatus 20 may store the fluctuation amount of own apparatus (each electric power generation apparatus 20) obtained as described above. In addition, the information acquisition unit 11 may acquire the fluctuation amount of each control apparatus 10 from each control apparatus 10.

The first calculation unit 12 calculates the electric power generation schedule of the whole of the plurality of electric power generation apparatuses 20 on the basis of the electric power generation schedule of each electric power generation apparatus 20 acquired by the information acquisition unit 11. In addition, the first calculation unit 12 calculates the total fluctuation amount at each timing in the electric power generation schedule of the whole of the plurality of electric power generation apparatuses 20 on the basis of the electric power generation schedule and the fluctuation amount of each electric power generation apparatus 20 acquired by the information acquisition unit 11.

The electric power generation schedule of the whole of the plurality of electric power generation apparatuses 20 is obtained by adding the generation electric power [W] of each electric power generation apparatus 20 at each timing.

It is possible to calculate the total fluctuation amount at each timing in the electric power generation schedule of the whole of the plurality of electric power generation apparatuses 20, for example, as follows.

“First Calculation Method”

The first calculation unit 12 may calculate ±(sum of a's value of electric power generation apparatuses 20 scheduled to perform an electric power generation operation at a first timing) as the total fluctuation amount at the first timing in the electric power generation schedule of the whole of the plurality of electric power generation apparatuses 20.

For example, it is assumed that first to third electric power generation apparatuses 20 are present as the plurality of electric power generation apparatuses 20 and respective fluctuation amounts of the first to third electric power generation apparatuses 20 are ±a1 to ±a3. In addition, it is assumed that the electric power generation schedule determines that the first and second electric power generation apparatuses 20 perform the electric power generation operation at the first timing (for example, 9 o'clock 00 minutes) and the third electric power generation apparatus 20 does not perform the electric power generation operation at the first timing (for example, 9 o'clock 00 minutes). In this case, the first calculation unit 12 calculates ±(a1+a2) as the total fluctuation amount of the whole of the plurality of electric power generation apparatuses 20 at the first timing.

In addition, it is assumed that the electric power generation schedule determines that the first to third electric power generation apparatuses 20 perform the electric power generation operation at a second timing (for example, 13 o'clock 00 minutes). In this case, the first calculation unit 12 calculates ±(a1+a2+a3) as the total fluctuation amount of the whole of the plurality of electric power generation apparatuses 20 at the second timing.

“Second Calculation Method”

The first calculation unit 12 may calculate ±amax as the total fluctuation amount at the first timing in the electric power generation schedule of the whole of the plurality of electric power generation apparatuses 20. The amax means the largest value among a's value of electric power generation apparatuses 20 scheduled to perform the electric power generation operation at the first timing.

For example, it is assumed that first to third electric power generation apparatuses 20 are present as the plurality of electric power generation apparatuses 20, the respective fluctuation amounts of the first to third electric power generation apparatuses 20 are ±a1 to ±a3, and a relation of a1<a2<a3 is satisfied. In addition, it is assumed that the electric power generation schedule determines that the first and second electric power generation apparatuses 20 perform the electric power generation operation at the first timing (for example, 9 o'clock 00 minutes) and the third electric power generation apparatus 20 does not to perform the electric power generation operation at the first timing (for example, 9 o'clock 00 minutes). In this case, the first calculation unit 12 determines ±a2 as the total fluctuation amount of the whole of the plurality of electric power generation apparatuses 20 at the first timing.

In addition, it is assumed that the electric power generation schedule determines that the first to third electric power generation apparatuses 20 perform the electric power generation operation at a second timing (for example, 13 o'clock 00 minutes). In this case, the first calculation unit 12 determines ±a3 as the total fluctuation amount of the whole of the plurality of electric power generation apparatuses 20 at the second timing.

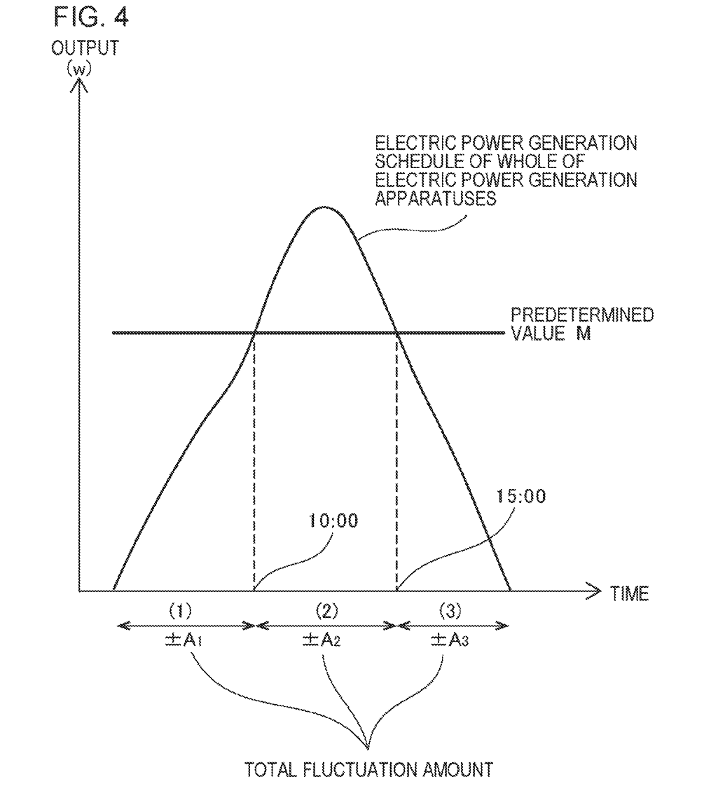

FIG. 4 illustrates a conceptual diagram of the electric power generation schedule and the total fluctuation amount of the whole of the plurality of electric power generation apparatuses 20 calculated by the first calculation unit 12. The figure shows a graph in which time is represented on a horizontal axis and an output (generation electric power) is represented on a vertical axis. In addition, a solid line shows an electric power generation schedule indicating a sum value of the generation electric power of the whole of the plurality of electric power generation apparatuses 20. In addition, the total fluctuation amounts (±A1 to ±A3) of the whole of the plurality of electric power generation apparatuses 20 at each of three time slots (1) to (3) are shown.

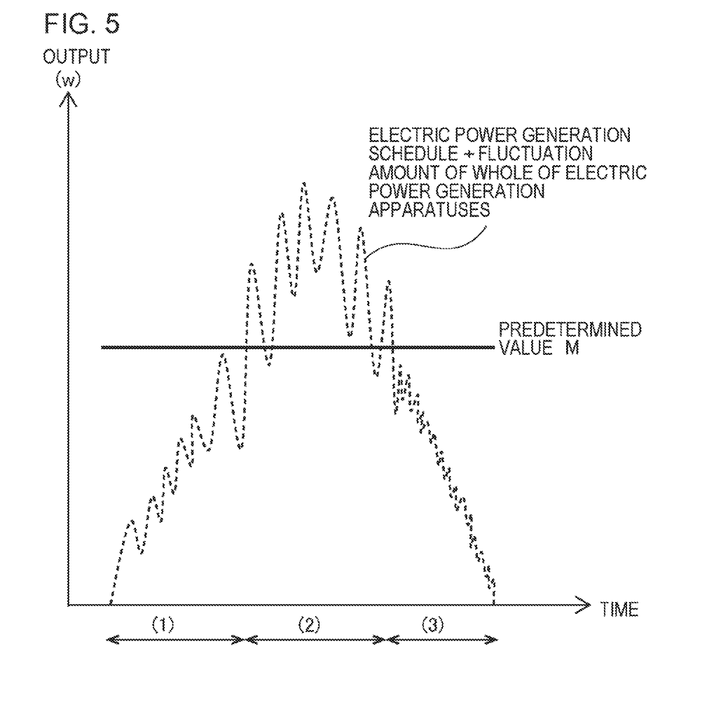

FIG. 5 illustrates a conceptual diagram summarizing the electric power generation schedule and the total fluctuation amount shown in FIG. 4 in a graph form. The magnitude relation of the total fluctuation amounts A1 to A3 is A3<A1<A2. It is known from the figure that an output is fluctuated in the time slot (2) when the total fluctuation amount is ±A2 largely.

Returning to FIG. 3, the second calculation unit 13 determines a control schedule of the energy accumulation apparatus 30 based on the electric power generation schedule and the total fluctuation amount of the whole of the plurality of electric power generation apparatuses 20.

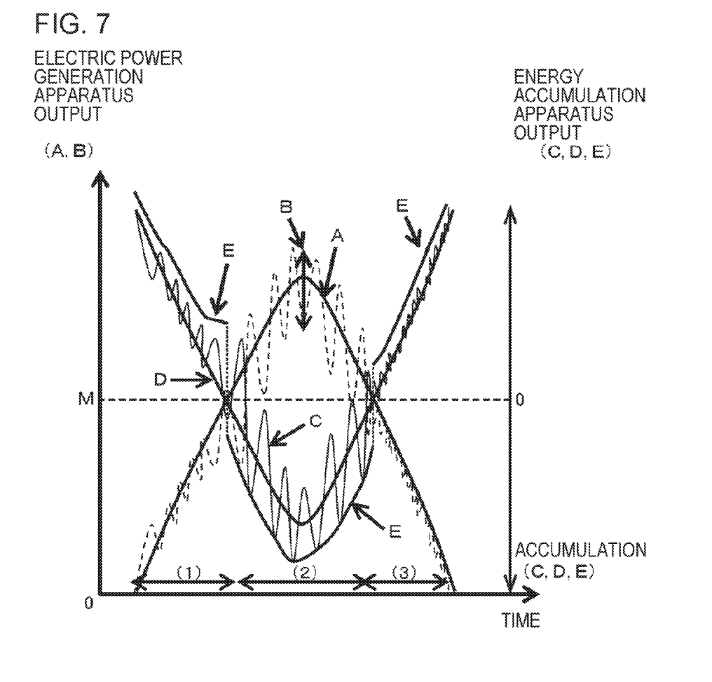

FIG. 7 illustrates a conceptual diagram. In FIG. 7, a horizontal axis represents a time axis. A vertical axis on the left side indicates the output of the whole of the plurality of electric power generation apparatuses 20 and corresponds to A and B of FIG. 7. A vertical axis on the right side indicates an output and accumulated electric power (charge electric power) of the whole of a plurality of energy accumulation apparatuses 30 and corresponds to C to E of FIG. 7. A of FIG. 7 indicates the electric power generation schedule of the whole of the plurality of electric power generation apparatuses 20. B of FIG. 7 indicates the total fluctuation amount of the whole of the plurality of electric power generation apparatuses 20. C to E of FIG. 7 will be described later.

For example, the second calculation unit 13 generates the control schedule of the energy accumulation apparatus 30 so as to satisfy the following two conditions. Hereinafter description will be made with the assumption that the generation electric power P [W] and a predetermined value M [W] corresponding to each timing are values averaged for every 30 minutes.
At a timing when the generation electric power P[W] in the electric power generation schedule of the whole of the plurality of electric power generation apparatuses 20 is larger than the predetermined value M (M≥0) corresponding to each timing, difference in electric power: the energy accumulation apparatus 30 is caused to accumulate (P−M) [W].
At a timing when the generation electric power P[W] in the electric power generation schedule of the whole of the plurality of electric power generation apparatuses 20 is smaller than the predetermined value M (M ≥0) corresponding to each timing, difference in electric power: the energy accumulation apparatus 30 is caused to output (M −P) [W].

The description will be given using FIG. 4. Here, in order to simplify the description, the predetermined value M is set to be constant, however, the value may be different for each time.

The second calculation unit 13 generates the control schedule for causing the energy accumulation apparatus 30 to output (discharge) (M −P) [W] at the timing when the generation electric power P [W] in the electric power generation schedule of the whole of the plurality of electric power generation apparatuses 20 is smaller than the predetermined value M (M ≥0) corresponding to each timing, that is, in the time slots from 0 o'clock to 10 o'clock and from 15 o'clock to 24 o'clock (refer to D of FIG. 7).

In addition, the second calculation unit 13 generates the control schedule for accumulating (charging) (P−M) [W] in the energy accumulation apparatus 30 at the timing when the generation electric power P [W] in the electric power generation schedule of the whole of the plurality of electric power generation apparatuses 20 is larger than the predetermined value M (M ≥0) corresponding to each timing, that is, in the time slot from 10 o'clock to 15 o'clock (refer to D of FIG. 7).

As described above, the second calculation unit 13 calculates the control schedule of the energy accumulation apparatus 30, and thus it is possible to secure supply reserve.

Note that the second calculation unit 13 may generate the control schedule of the energy accumulation apparatus 30 in consideration of the total fluctuation amount. That is, the second calculation unit 13 may calculate the fluctuation amount at each timing in the control schedule (refer to D of FIG. 7) of the energy accumulation apparatus 30 calculated as described above, based on the total fluctuation amount. In addition, the second calculation unit 13 may determine the control schedule (refer to E of FIG. 7) of the energy accumulation apparatus 30 in consideration of the total fluctuation amount, based on the fluctuation amount at each timing in the control schedule of the energy accumulation apparatus 30. Therefore, it is possible to secure adjustment power with respect to the fluctuation amount of the electric power generation apparatus 20 by generating the control schedule of the energy accumulation apparatus 30 in consideration of the total fluctuation amount. Accordingly, it is possible to calculate the control schedule of the energy accumulation apparatus 30 with higher accuracy.

For example, the second calculation unit 13 may adopt (determine) the total fluctuation amount at each timing as the fluctuation amount at each timing in the control schedule of the energy accumulation apparatus 30 calculated as described above. In a case the determination is made as described above, the control schedule of the energy accumulation apparatus 30 of D of FIG. 7 may be fluctuated as shown in C of FIG. 7.

For example, in a time slot when the energy accumulation apparatus 30 is caused to output (M −P) [W] as the supply reserve (hereinafter, an output time slot), in a case where the total fluctuation amount at each timing is calculated as ±An [W/sec], the second calculation unit 13 may calculate the control schedule by setting (M −P+k*An) [W] at each of a plurality of timings as a lower limit of the output [W] to be secured by the plurality of energy accumulation apparatuses 30 (refer to E of FIG. 7). Here, k is an empirically obtained proportionality constant [sec].

In addition, the second calculation unit 13 may calculate an electric power amount [Wh] output in a case where an output continues in (M −P+k*An) [W] during the output time slot, as a lower limit value of an electric power amount [Wh] to be accumulated in the plurality of energy accumulation apparatuses 30.

In addition, in a time slot when energy accumulation apparatus 30 is caused to accumulate (P−M) [W] (hereinafter, an accumulation time slot), in a case where the total fluctuation amount at each timing is calculated as ±An [W/sec], the second calculation unit 13 may calculate the control schedule by setting (P−M+k*An) [W] at each of the plurality of timings as the lower limit of the charge (accumulation) electric power [W] to be secured by the plurality of energy accumulation apparatuses 30 (refer to E of FIG. 7).

In addition, the second calculation unit 13 may calculate an electric power amount [Wh] accumulated in a case where an accumulation continues in (P −M+k*An) [W] during the accumulation time slot, as a lower limit value of an empty capacity [Wh] to be prepared in the plurality of energy accumulation apparatuses 30.

In addition, after the second calculation unit 13 calculates the control schedule (the electric power [W] to be secured, the charge (accumulation) electric power [W] to be secured, the electric power amount [Wh] to be accumulated, the empty capacity [Wh] to be prepared, and the like) in the whole of the plurality of energy accumulation apparatuses 30 as described above, the second calculation unit 13 may determine the control schedule of each energy accumulation apparatus 30.

For example, a case is considered in which in the output time slot when the plurality of energy accumulation apparatuses 30 are caused to output (M −P) [W] as the supply reserve, in a case where the total fluctuation amount at each timing is calculated as ±An [W/sec], the second calculation unit 13 calculates (M −P+k*An) [W] as a lower limit of the output [W] to be secured by the plurality of energy accumulation apparatuses 30 and calculates (M −P+k*An)/2 [Wh] that is an electric power amount [Wh] output when output is continued with a 30-minute average value of (M −P+k*An) [W], as a lower limit of the electric power amount [Wh] to be accumulated in the plurality of energy accumulation apparatuses 30. In a case where the number of controllable energy accumulation apparatuses 30 is N, when a sum value [W] of the output of the energy accumulation apparatuses 30 is larger than (M −P+k*An) [W], (M −P+k*An)/N [W] is distributed to each energy accumulation apparatus 30. In addition, when the accumulated electric power amount [Wh] is larger than (M −P+k*An)/2 [Wh]. (M −P+k*An)/2N [Wh] is distributed to each energy accumulation apparatus 30.

In addition, a case is considered in which in the accumulation time slot when the energy accumulation apparatuses 30 are caused to charge (accumulate) (P−M) [W] as the supply reserve, in a case where the total fluctuation amount at each timing is calculated as ±An [W/sec], the second calculation unit 13 calculates (P−M+k*An) [W] as a lower limit of the charge (accumulation) electric power [W] to be secured by the plurality of energy accumulation apparatuses 30 and calculates (P−M+k*An)/2 [Wh] that is a charge (accumulation) electric power amount [Wh] when output is continued with a 30-minute average value of (P −M+k*An) [W], as a lower limit of the empty capacity [Wh] to be prepared in the plurality of energy accumulation apparatuses 30. In a case where the number of controllable energy accumulation apparatuses 30 is N, when a sum value [W] of the charge (accumulation) electric power of the energy accumulation apparatuses 30 is larger than (P−M+k*An) [W], (P−M+k*An)/N [W] is distributed to each energy accumulation apparatus 30. In addition, when the empty capacity [Wh] to be prepared is larger than (P−M+k*An)/2 [Wh]. (P−M+k*An)/2N [Wh] is distributed to each energy accumulation apparatus 30.

Here, although the example in which the equal distribution is performed on the N energy accumulation apparatuses 30 is shown, a proportional distribution may also be performed according to a ratio of the empty capacity [Wh], a ratio of the accumulated electric power amount [Wh], a ratio of a rated output [W], or the like.

The second calculation unit 13 determines the control schedule of the energy accumulation apparatus 30 as described above on the basis of the electric power generation schedule of the electric power generation apparatus 20.

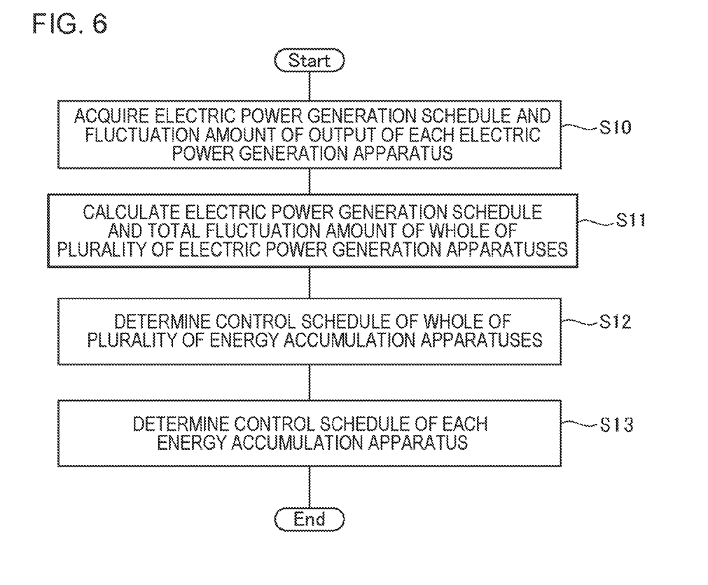

Next, an example of a flow of a process of the control apparatus 10 of the present example embodiment will be described using a flowchart of FIG. 6.

First, the information acquisition unit 11 acquires the electric power generation schedule and the fluctuation amount of the output of each of the plurality of electric power generation apparatuses 20 (S10).

Then, The first calculation unit 12 calculates the electric power generation schedule of the whole of the plurality of electric power generation apparatuses 20 and the total fluctuation amount at each timing in the electric power generation schedule of the whole of the plurality of electric power generation apparatuses 20, on the basis of the electric power generation schedule and the fluctuation amount of each of the plurality of electric power generation apparatuses 20 acquired in S10 (S11).

Then, the second calculation unit 13 determines the control schedule of the whole of the plurality of energy accumulation apparatuses 30 based on the electric power generation schedule and the total fluctuation amount of the whole of the plurality of electric power generation apparatuses 20 (S12).

After S12, the second calculation unit 13 determines the control schedule of each energy accumulation apparatus 30 based on the control schedule of the whole of the plurality of energy accumulation apparatuses 30 (S13). Details are as described above.

According to the present example embodiment described above, it is possible to calculate not only the electric power generation schedule of the whole of the plurality of electric power generation apparatuses 20 but also the total fluctuation amount at each timing indicated by the electric power generation schedule. In addition, it is possible to determine the control schedule of the energy accumulation apparatus 30 based on the calculation result.

The control schedule of each energy accumulation apparatus 30 is determined in order to output or accumulate electric power on the basis of the control schedule and the fluctuation amount described above. Therefore, it is possible to reduce an occurrence of an output shortage, an energy shortage, an empty capacity shortage, and the like caused by a fluctuation amount. As a result, it is possible to cause the energy accumulation apparatus 30 to perform a suitable operation and to stabilize electric power quality of an electric power distribution network.

Hereinafter, an example of a reference form will be added.

1. A control apparatus including:

an information acquisition unit that acquires an electric power generation schedule and a fluctuation amount of an output of each of a plurality of electric power generation apparatuses;

a first calculation unit that calculates, on the basis of the electric power generation schedule and the fluctuation amount, an electric power generation schedule of the whole of the plurality of electric power generation apparatuses, and a total fluctuation amount at each timing in the electric power generation schedule of the whole of the plurality of electric power generation apparatuses; and

a second calculation unit that determines a control schedule of an energy accumulation apparatus on the basis of the electric power generation schedule and the total fluctuation amount of the whole of the plurality of electric power generation apparatuses.

2. The control apparatus according to 1,

in which the second calculation unit determines the fluctuation amount at each timing in the control schedule.

3. The control apparatus according to 1,

in which the first calculation unit calculates the largest fluctuation amount among fluctuation amounts of the electric power generation apparatuses scheduled to perform an electric power generation operation at a first timing as the total fluctuation amount.

4. The control apparatus according to any of 1 to 3,

in which the second calculation unit determines the total fluctuation amount at each timing in the electric power generation schedule of the whole of the plurality of electric power generation apparatuses as the fluctuation amount at each timing in the control schedule.

5. The control apparatus according to any of 1 to 4,

in which in a case where generation electric power in the electric power generation schedule in the whole of the plurality of electric power generation apparatuses is smaller than a predetermined value corresponding to each timing, the second calculation unit determines the control schedule of the energy accumulation apparatus causing the energy accumulation apparatus to discharge a difference between the predetermined value and the generation electric power.

6. The control apparatus according to any of 1 to 5,

in which in a case where generation electric power in the electric power generation schedule in the whole of the plurality of electric power generation apparatuses is larger than a predetermined value corresponding to each timing, the second calculation unit determines the control schedule of the energy accumulation apparatus causing the energy accumulation apparatus to accumulate a difference between the predetermined value and the generation electric power.

7. The control apparatus according to 5 or 6,

in which the second calculation unit determines the control schedule of the energy accumulation apparatus on the basis of a difference in electric power between the predetermined value and the generation electric power, and the total fluctuation amount

8. The control apparatus according to 7,

in which in a case where the generation electric power is lower than the predetermined value, the second calculation unit determines the control schedule of the energy accumulation apparatus so that output electric power is larger than a sum of a product of the total fluctuation amount and a proportionality constant, and the difference in electric power.

9. The control apparatus according to 8,

in which the second calculation unit determines the control schedule of the energy accumulation apparatus so that a charge electric power amount is larger than an electric power amount of a case where the sum of the product of the total fluctuation amount and the proportionality constant, and the difference in electric power is continuously output in a time slot in which the generation electric power is lower than the predetermined value.

10. The control apparatus according to any one of 7 to 9,

in which in a case where the generation electric power is higher than the predetermined value, the second calculation unit determines the control schedule of the energy accumulation apparatus so that charge electric power is larger than the sum of the product of the total fluctuation amount and the proportionality constant, and the difference in electric power.

11. The control apparatus according to 10,

in which the second calculation unit determines the control schedule of the energy accumulation apparatus so that an empty capacity is larger than an electric power amount of a case where the sum of the product of the total fluctuation amount and the proportionality constant, and the difference in electric power is continuously charged in a time slot in which the generation electric power is higher than the predetermined value.

12. The control apparatus according to any one of 1 to 11,

in which the second calculation unit determines the control schedule of each energy accumulation apparatus on the basis of an empty capacity, an accumulated electric power amount, and a rated output of each of the plurality of energy accumulation apparatuses.

13. A control method executed by a computer, the control method including:

an information acquisition step of acquiring an electric power generation schedule and a fluctuation amount of an output of each of a plurality of electric power generation apparatuses;

a first calculation step of calculating, on the basis of the electric power generation schedule and the fluctuation amount, an electric power generation schedule of the whole of the plurality of electric power generation apparatuses, and a total fluctuation amount at each timing in the electric power generation schedule of the whole of the plurality of electric power generation apparatuses; and

a second calculation step of determining a control schedule of an energy accumulation apparatus on the basis of the electric power generation schedule and the total fluctuation amount of the whole of the plurality of electric power generation apparatuses.

13-2. The control method according to 13,

in which in the second calculation step, the fluctuation amount at each timing in the control schedule is determined.

13-3. The control method according to 13,

in which in the first calculation step, the largest fluctuation amount among fluctuation amounts of the electric power generation apparatuses scheduled to perform an electric power generation operation at a first timing is calculated as the total fluctuation amount.

13-4. The control method according to any one of 13 to 13-3,

in which in the second calculation step, the total fluctuation amount at each timing in the electric power generation schedule of the whole of the plurality of electric power generation apparatuses is determined as the fluctuation amount at each timing in the control schedule.

13-5. The control method according to any one of 13 to 13-4,

in which in the second calculation step, in a case where generation electric power in the electric power generation schedule in the whole of the plurality of electric power generation apparatuses is smaller than a predetermined value corresponding to each timing, the control schedule of the energy accumulation apparatus causing the energy accumulation apparatus to discharge a difference between the predetermined value and the generation electric power is determined.

13-6. The control method according to any one of 13 to 13-5,

in which in the second calculation step, in a case where generation electric power in the electric power generation schedule in the whole of the plurality of electric power generation apparatuses is larger than a predetermined value corresponding to each timing, the control schedule of the energy accumulation apparatus causing the energy accumulation apparatus to accumulate a difference between the predetermined value and the generation electric power is determined.

13-7. The control method according to 13-5 or 13-6,

in which in the second calculation step, the control schedule of the energy accumulation apparatus is determined on the basis of a difference in electric power between the predetermined value and the generation electric power, and the total fluctuation amount

13-8. The control method according to 13-7,

in which in the second calculation step, in a case where the generation electric power is lower than the predetermined value, the control schedule of the energy accumulation apparatus is determined so that output electric power is larger than a sum of a product of the total fluctuation amount and a proportionality constant and the difference in electric power.

13-9. The control method according to 13-8,

in which in the second calculation step, the control schedule of the energy accumulation apparatus is determined so that a charge electric power amount is larger than an electric power amount of a case where the sum of the product of the total fluctuation amount and the proportionality constant, and the difference in electric power is continuously output in a time slot in which the generation electric power is lower than the predetermined value.

13-10. The control method according to any one of 13-7 to 13-9,

in which in the second calculation step, in a case where the generation electric power is higher than the predetermined value, the control schedule of the energy accumulation apparatus is determined so that charge electric power is larger than the sum of the product of the total fluctuation amount and the proportionality constant, and the difference in electric power.

13-11. The control method according to 13-10,

in which in the second calculation step, the control schedule of the energy accumulation apparatus is determined so that an empty capacity is larger than an electric power amount of a case where the sum of the product of the total fluctuation amount and the proportionality constant, and the difference in electric power is continuously charged in the time slot in which the generation electric power is higher than the predetermined value.

13-12. The control method according to any one of 13 to 13-11,

in which in the second calculation unit, the control schedule of each energy accumulation apparatus is determined on the basis of an empty capacity, an accumulated electric power amount, and a rated output of each of the plurality of energy accumulation apparatuses.

14. A program causing a computer to function as:

an information acquisition unit that acquires an electric power generation schedule and a fluctuation amount of an output of each of a plurality of electric power generation apparatuses;

a first calculation unit that calculates, on the basis of the electric power generation schedule and the fluctuation amount, an electric power generation schedule of the whole of the plurality of electric power generation apparatuses, and a total fluctuation amount at each timing in the electric power generation schedule of the whole of the plurality of electric power generation apparatuses; and

a second calculation unit that determines a control schedule of an energy accumulation apparatus on the basis of the electric power generation schedule and the total fluctuation amount of the whole of the plurality of electric power generation apparatuses.

14-2. The program according to 14,

in which the second calculation unit determines the fluctuation amount at each timing in the control schedule.

14-3. The program according to 14,

in which the first calculation unit calculates the largest fluctuation amount among fluctuation amounts of the electric power generation apparatuses scheduled to perform an electric power generation operation at a first timing as the total fluctuation amount.

14-4. The program according to any of 14 to 14-3,

in which the second calculation unit determines the total fluctuation amount at each timing in the electric power generation schedule of the whole of the plurality of electric power generation apparatuses as the fluctuation amount at each timing in the control schedule.

14-5. The program according to any of 14 to 14-4,

in which in a case where generation electric power in the electric power generation schedule in the whole of the plurality of electric power generation apparatuses is smaller than a predetermined value corresponding to each timing, the second calculation unit determines the control schedule of the energy accumulation apparatus causing the energy accumulation apparatus to discharge a difference between the predetermined value and the generation electric power.

14-6. The program according to any of 14 to 14-5,

in which in a case where generation electric power in the electric power generation schedule in the whole of the plurality of electric power generation apparatuses is larger than a predetermined value corresponding to each timing, the second calculation unit determines the control schedule of the energy accumulation apparatus causing the energy accumulation apparatus to accumulate a difference between the predetermined value and the generation electric power.

14-7. The program according to 14-5 or 14-6,

in which the second calculation unit determines the control schedule of the energy accumulation apparatus on the basis of a difference in electric power between the predetermined value and the generation electric power, and the total fluctuation amount

14-8. The program according to 14-7,

in which in a case where the generation electric power is lower than the predetermined value, the second calculation unit determines the control schedule of the energy accumulation apparatus so that output electric power is larger than a sum of a product of the total fluctuation amount and a proportionality constant and the difference in electric power.

14-9. The program according to 14-8,

in which the second calculation unit determines the control schedule of the energy accumulation apparatus so that a charge electric power amount is larger than an electric power amount of a case where the sum of the product of the total fluctuation amount and the proportionality constant, and the difference in electric power is continuously output in a time slot in which the generation electric power is lower than the predetermined value.

14-10. The program according to any one of 14-7 to 14-9,

in which in a case where the generation electric power is higher than the predetermined value, the second calculation unit determines the control schedule of the energy accumulation apparatus so that charge electric power is larger than the sum of the product of the total fluctuation amount and the proportionality constant, and the difference in electric power.

14-11. The program according to 14-10,

in which the second calculation unit determines the control schedule of the energy accumulation apparatus so that an empty capacity is larger than an electric power amount of a case where the sum of the product of the total fluctuation amount and the proportionality constant, and the difference in electric power is continuously charged in a time slot in which the generation electric power is higher than the predetermined value.

14-12. The program according to any one of 14-1 to 14-11,

in which the second calculation unit determines the control schedule of each energy accumulation apparatus on the basis of an empty capacity, an accumulated electric power amount, and a rated output of each of the plurality of energy accumulation apparatuses.

This application is based upon and claims the benefit of priority from Japanese Patent Application No. 2016-053506, filed Mar. 17, 2016, the entire contents of which are incorporated herein by reference.

1. A control apparatus comprising:
at least one memory configured to store one or more instructions; and
at least one processor configured to execute the one or more instructions to:
acquire an electric power generation schedule and a fluctuation amount of an output of each of a plurality of electric power generation apparatuses;
calculate, on the basis of the electric power generation schedule and the fluctuation amount, an electric power generation schedule of the whole of the plurality of electric power generation apparatuses, and a total fluctuation amount at each timing in the electric power generation schedule of the whole of the plurality of electric power generation apparatuses; and
determine a control schedule of an energy accumulation apparatus on the basis of the electric power generation schedule and the total fluctuation amount of the whole of the plurality of electric power generation apparatuses.

2. The control apparatus according to claim 1,
wherein the processor is further configured to execute the one or more instructions to determine the fluctuation amount at each timing in the control schedule.

3. The control apparatus according to claim 1,
wherein the processor is further configured to execute the one or more instructions to calculate the largest fluctuation amount among fluctuation amounts of the electric power generation apparatuses scheduled to perform an electric power generation operation at a first timing as the total fluctuation amount.

4. The control apparatus according to claim 1,
wherein the processor is further configured to execute the one or more instructions to determine the total fluctuation amount at each timing in the electric power generation schedule of the whole of the plurality of electric power generation apparatuses as the fluctuation amount at each timing in the control schedule.

5. The control apparatus according to claim 1,
wherein the processor is further configured to execute the one or more instructions to, in a case where generation electric power in the electric power generation schedule in the whole of the plurality of electric power generation apparatuses is smaller than a predetermined value corresponding to each timing, determine the control schedule of the energy accumulation apparatus causing the energy accumulation apparatus to discharge a difference between the predetermined value and the generation electric power.

6. The control apparatus according to claim 1,
wherein the processor is further configured to execute the one or more instructions to, in a case where generation electric power in the electric power generation schedule in the whole of the plurality of electric power generation apparatuses is larger than a predetermined value corresponding to each timing, determine the control schedule of the energy accumulation apparatus causing the energy accumulation apparatus to accumulate a difference between the predetermined value and the generation electric power.

7. The control apparatus according to claim 5,
wherein the processor is further configured to execute the one or more instructions to determine the control schedule of the energy accumulation apparatus on the basis of a difference in electric power between the predetermined value and the generation electric power, and the total fluctuation amount.

8. The control apparatus according to claim 7,
wherein the processor is further configured to execute the one or more instructions to, in a case where the generation electric power is lower than the predetermined value, determine the control schedule of the energy accumulation apparatus so that output electric power is larger than a sum of a product of the total fluctuation amount and a proportionality constant, and the difference in electric power.

9. The control apparatus according to claim 8,
wherein the processor is further configured to execute the one or more instructions to determine the control schedule of the energy accumulation apparatus so that a charge electric power amount is larger than an electric power amount of a case where the sum of the product of the total fluctuation amount and the proportionality constant, and the difference in electric power is continuously output in a time slot in which the generation electric power is lower than the predetermined value.

10. The control apparatus according to claim 7,
wherein the processor is further configured to execute the one or more instructions to, in a case where the generation electric power is higher than the predetermined value, determine the control schedule of the energy accumulation apparatus so that charge electric power is larger than the sum of the product of the total fluctuation amount and the proportionality constant, and the difference in electric power.

11. The control apparatus according to claim 10,
wherein the processor is further configured to execute the one or more instructions to determine the control schedule of the energy accumulation apparatus so that an empty capacity is larger than an electric power amount of a case where the sum of the product of the total fluctuation amount and the proportionality constant, and the difference in electric power is continuously charged in a time slot in which the generation electric power is higher than the predetermined value.

12. The control apparatus according to claim 1,
wherein the processor is further configured to execute the one or more instructions to determine the control schedule of each energy accumulation apparatus on the basis of an empty capacity, an accumulated electric power amount, and a rated output of each of the plurality of energy accumulation apparatuses.

13. A control method executed by a computer, the control method comprising:
acquiring an electric power generation schedule and a fluctuation amount of an output of each of a plurality of electric power generation apparatuses;
calculating, on the basis of the electric power generation schedule and the fluctuation amount, an electric power generation schedule of the whole of the plurality of electric power generation apparatuses, and a total fluctuation amount at each timing in the electric power generation schedule of the whole of the plurality of electric power generation apparatuses; and
determining a control schedule of an energy accumulation apparatus on the basis of the electric power generation schedule and the total fluctuation amount of the whole of the plurality of electric power generation apparatuses.

14. A non-transitory storage medium storing a program causing a computer to:
acquire an electric power generation schedule and a fluctuation amount of an output of each of a plurality of electric power generation apparatuses;
calculate, on the basis of the electric power generation schedule and the fluctuation amount, an electric power generation schedule of the whole of the plurality of electric power generation apparatuses, and a total fluctuation amount at each timing in the electric power generation schedule of the whole of the plurality of electric power generation apparatuses; and
determine a control schedule of an energy accumulation apparatus on the basis of the electric power generation schedule and the total fluctuation amount of the whole of the plurality of electric power generation apparatuses.
